(19) United States
(12) Patent Application Publication
(10) Pub. No.: US 2022/0395130 A1
(43) Pub. Date: Dec. 15, 2022

(54) Methods for Preparing Instant Coffee and Coffee Prepared by These Methods

(71) Applicant: Stay Golden Coffee, LLC, Nashville, TN (US)

(72) Inventors: John Quinn, Nashville, TN (US); Sean Stewart, Nashville, TN (US)

(21) Appl. No.: 17/640,557

(22) PCT Filed: Sep. 11, 2020
(86) PCT No.: PCT/US2020/050383

§ 371 Date: Mar. 4, 2022

Related U.S. Application Data
(60) Provisional application No. 62/899,412, filed on Sep. 12, 2019.

(51) Int. Cl. A47J 31/18

(52) U.S. Cl. CPC A47J 31/18

(57) ABSTRACT

Processes and apparatus for preparing instant coffee are described. In these processes, brewed coffee is fortified by adding coffee liquids separated from the surface of a separately-brewed batch of coffee. This fortification may increase the levels of lipids and other compounds that tend to be lost in greater amounts during lyophilization and other drying processes. The resulting fortified coffee, separated from coffee grounds and chilled to an appropriate temperature, may be held in a tank that has been washed with an acidifier, such as lemon juice or another fruit-derived citric acid, while awaiting lyophilization or another drying process.

### TECHNICAL FIELD

The invention relates to methods for preparing lyophilized coffee and to coffee prepared by these methods.

### BACKGROUND

Traditionally, coffee is brewed by grinding roasted coffee beans and placing those coffee grounds in contact with water, usually hot water. This takes time, and the equipment necessary to do it is not always readily available. Thus, for several hundred years, there have been various forms of coffee that can be prepared without traditional brewing. These forms of coffee are typically referred to as instant coffee.

Today, the term “instant coffee” refers to brewed coffee that has been dried, usually either by spray drying or by lyophilization (i.e., freeze-drying or sublimation). Although the 20^{th} century brought with it a number of significant improvements in the methods by which instant coffee is manufactured, the beverage is still generally viewed as lackluster as compared with the taste of traditional fresh-brewed coffee.

### BRIEF SUMMARY

One aspect of the invention relates to methods and processes for preparing instant coffee. In processes according to this aspect of the invention, brewed coffee is fortified by adding coffee liquids separated from the surface of a separately-brewed batch of coffee. This fortification may increase the levels of lipids and other compounds that tend to be lost in greater amounts during lyophilization and other drying processes. The resulting fortified coffee, separated from coffee grounds and chilled to an appropriate temperature, may be held in a tank that has been washed with an acidifier, such as lemon juice or fruit-derived citric acid, while awaiting lyophilization or another drying process.

In processes according to some embodiments of the invention, coffee brewed in a main brewing vessel is flowed through the top of an auxiliary brewing vessel to skim compounds that rise to the surface of brewed coffee in that vessel. The coffee that is flowed through the top of the auxiliary vessel may be pressurized by pumping or by a pressurized gas source.

Another aspect of the invention relates to a fortified, dried coffee produced by processes such as those described above.

Other aspects, features, and advantages of the invention will be set forth in the description that follows.

### BRIEF DESCRIPTION OF THE DRAWING FIGURE

FIG. 1 is a schematic diagram of an apparatus and process for making instant coffee according to one embodiment of the invention; and

FIG. 2 is a schematic diagram of an apparatus and process according to another embodiment of the invention.

### DETAILED DESCRIPTION

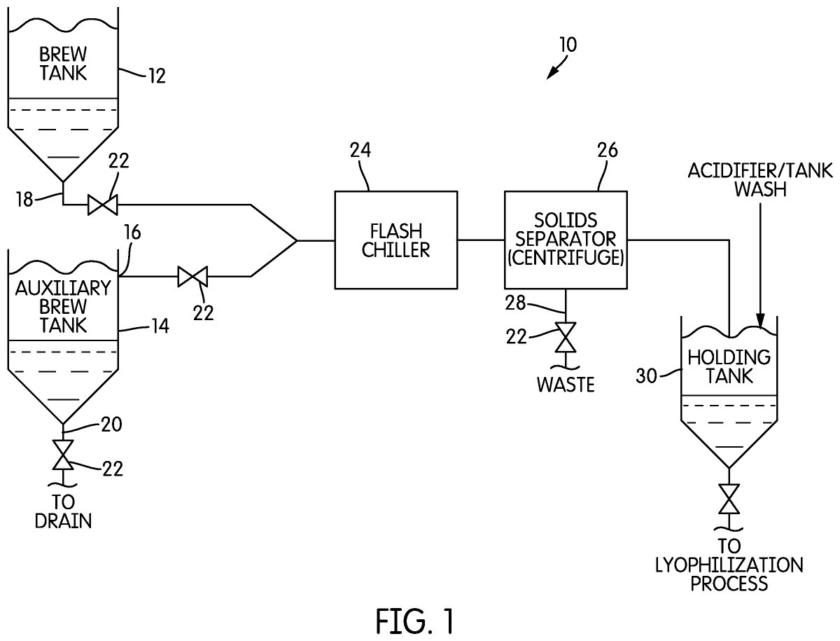

FIG. 1 is a schematic diagram of a process, generally indicated at 10, for making instant coffee according to one embodiment of the invention. FIG. 1 illustrates process 10 using industrial equipment, but instant coffee may be prepared at any scale within the scope of the invention. The production process 10 may be continuous, performed in batches, or performed only in small quantities. The equipment used to perform process 10 may be either custom equipment or equipment that is adapted from other food preparation processes. For example, beer-brewing equipment can be readily adapted to perform process 10.

FIG. 1 illustrates only a portion of process 10. While not shown in FIG. 1, as those of skill in the art will appreciate, a coffee-making process involves coffee beans. The preparatory process for the coffee beans is not shown in FIG. 1. Generally speaking, fresh or “green” coffee beans are sourced from a single location or from multiple locations. Different varieties of beans may be mixed together, if desired, before the beans are roasted. The coffee beans used in embodiments of the present invention may be of any type, and they may be roasted to any specifications. For example, they may be light roast, medium roast, or dark roast beans, of any variety and sourced from any location. The roast coffee beans are then ground prior to the equipment and steps illustrated in FIG. 1.

As illustrated in FIG. 1, process 10 begins with brewing coffee from coffee beans. Specifically, ground coffee beans and water are placed in a brew tank 12 to brew. Various ratios of coffee to water may be used, but as one example, the present inventors have found a ratio of 1:5 (coffee to water) is suitable in at least some embodiments. In this description, unless otherwise stated, ratios such as this are weight-to-weight ratios. The brew tank 12 may include apparatus for heating water or for maintaining the temperature of the brew, or water at an appropriate temperature may be prepared elsewhere and placed in the brew tank 12.

Process 10 also includes an auxiliary brew tank 14. The present inventors have found that when coffee undergoes a traditional lyophilization process, certain lipids and other compounds that are relatively less soluble in water are lost in greater amounts, which affects the taste of the resulting product. For that reason, in process 10, the coffee is fortified with these compounds before lyophilization or other final drying steps.

More specifically, coffee is also brewed in the auxiliary brew tank 14 with a separate set of coffee beans. The coffee in the auxiliary brew tank 14 is typically of the same type and roast as the coffee in the brew tank 12, although it may be different in some embodiments. The lipids and other compounds in question tend to separate from the more water-soluble components of the coffee and rise to the surface of the tank 14. These compounds, floating at or near the surface of the auxiliary brew tank 14, are separated from the rest of the coffee brewed in the auxiliary brew tank 14 and are used to fortify the coffee brewed in the brew tank 12.

While any separation process may be used to separate the lipid and other compounds in the auxiliary brew tank coffee from the underlying brewed coffee, in the illustrated embodiment, the drain 16 for the auxiliary brew tank lies close to the fill line for the tank, meaning that the layers closest to the surface of the brewed coffee will be drawn off first. By contrast, the drain 18 for the brew tank 12 is in a more traditional position, in this illustration, at or near the bottom of the tank. The auxiliary brew tank 14 has a secondary drain 20 that is used to drain off the unused coffee liquid. In some cases, the unused liquid may be recycled; in others, it may simply be a waste product of process 10. As shown in FIG. 1, valves 22, which may be either manual or automatic, control the flow of brewed coffee into the rest of the process.

Coffee may be brewed in the brew tank 12 and the auxiliary brew tank 14 simultaneously. Alternatively, coffee may be brewed in the auxiliary brew tank 14 on a different schedule, to build up a feedstock of coffee liquids—coffee lipids and other compounds that are added to the coffee from the brew tank 12 to fortify it. In some cases, the feedstock of coffee beans used in the auxiliary brew tank 14 may be chosen because they are richer in the lipids and other compounds that are to be used in fortification. Typically, 20-30 mL of fluid are skimmed or separated from the coffee in the auxiliary tank 14 per liter of liquid in the tank.

While the auxiliary tank 14 is illustrated schematically in FIG. 1 as being the same size as the brew tank 12, the auxiliary tank 14 may be smaller than the brew tank 12. It should also be understood that although the term “tank” is used for convenience, any suitable vessel may be used for brewing coffee in process 10, and the term “tank,” as used here, should be construed broadly to include other types of vessels. Additionally, while two tanks 12, 14 are described, in some cases, a single brew tank with an appropriately-located drain or drains could be used for both the main brew and the auxiliary brew, if the main brew and the auxiliary brew are done at different times and the separated liquids from the auxiliary brew are held until needed in a storage vessel. In that case, process 10 may simply comprise brewing a first volume of coffee and, separately, brewing a second volume of coffee, irrespective of the tanks that are used for the brewing.

The coffee from the brew tank 12 and the fortifying compounds that are drawn off from the separating drain 16 of the auxiliary brew tank 14 flow together or separately into a flash chiller 24 that cools the combined liquid to an appropriate temperature. The flash chiller 24 typically reduces the temperature of the coffee, which may be near the boiling point of water in some cases, to 35-50° F. (2-10° C.). After chilling, the coffee is sent to a separator 26 to separate out any solid coffee grounds or other solids that may be present. The separator 26 has a drain or waste port 28 through which the solids are removed. The chilled, separated liquid passes to a holding tank 30.

While the separator 26 is shown as the only means of separation in process 10, in some cases, coffee grounds may be separated from liquids earlier in the process by a separate set of filters or other separation equipment, with the separator 26 used as a finishing step.

The holding tank 30 holds chilled, fortified coffee while awaiting the final steps of the lyophilization process. As those of skill in the art will appreciate, many of the compounds that create the complex flavor of coffee are volatile and begin to evaporate and otherwise dissipate immediately after brewing. For that reason, the tank 30 and its environment may be controlled to maintain the flavor of the fortified coffee while it awaits lyophilization or another form of drying or final processing. This may involve controlling factors like temperature and humidity, preventing evaporation, providing agitation within the holding tank 30, and other such things. Of course, these sorts of controls may extend to elements of process 10 in addition to the final holding tank 30.

Beyond the above environmental factors and considerations, the inventors have found that it is helpful to control the pH of at least some of the surfaces with which the coffee comes into contact. Additionally, the inventors have found that at least incidental contact with acidifying process agents may have a beneficial effect on the flavor of the coffee. For example, the holding tank 30 may be washed with an acidifying process agent before the coffee is placed in it. Incidental contact between the coffee and the small amount of acidifier that remains in the holding tank 30 or clings to its inner surfaces after washing will typically be enough to create a beneficial effect.

While many different acids may be used for acidification, the inventors have found that natural lemon juice and fruit-derived citric acid are two particularly preferable options. The amount of the acidifier that mixes with the coffee may be miniscule, e.g., between about 0.01% and 0.02%. In many jurisdictions, these amounts are too small for the acidifier to be considered a food additive.

The coffee from the holding tank 30 is ultimately directed into a lyophilization or other drying process. The final drying process is often a batch process with, e.g., the chilled, fortified coffee placed in trays for lyophilization. The resulting lyophilizate can be reconstituted with water at a typical ratio, e.g., 1:70, for consumption. However, the lyophilizate may also be used as a food additive and flavoring agent in its own right. Moreover, while some form of drying process will be typical in embodiments of the invention, nothing prevents the coffee in the holding tank 30 from being packaged as-is for shipping and consumption.

As was noted briefly above, while process 10 is a relatively large-scale production process, instant coffee according to embodiments of the present invention may be made in much smaller batches using light commercial and even home equipment.

There are many potential variations on process 10 of FIG. 1. For one, although FIG. 1 shows the components as being connected by piping, that need not be the case. Fluid from one part of the process may be conveyed to other equipment and other steps of the process by other means, such as by collecting it in large, portable containers.

One task that may see any number of variations is the auxiliary brewing process in which additional coffee compounds are produced, separated from the rest of the brewed coffee, and used as a fortifying agent for a main batch of brewed coffee. As described above, one way of doing this is to skim the compounds from the top of the brewed coffee.

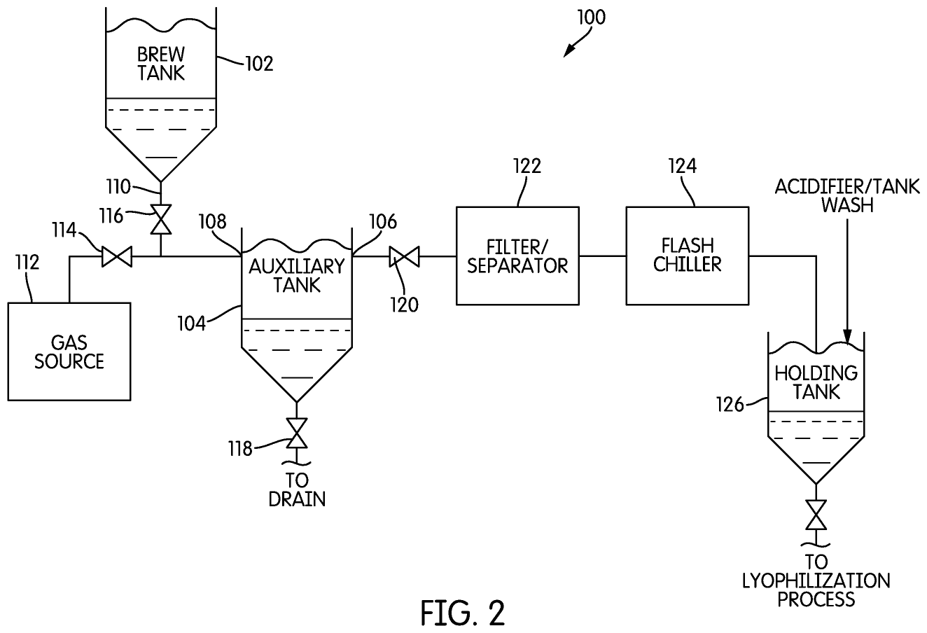

FIG. 2 illustrates an apparatus and process, generally indicated at 100, according to another embodiment of the invention. In the apparatus 100, coffee is brewed in a brew tank 102 and also in an auxiliary tank 104, as described above. As in process 10 described above, the auxiliary tank 104 has a primary drain 106 near the top of the tank 104, positioned to skim liquids from the surface.

In the description above, it is assumed that if such a drain 16 is opened, gravity will provide sufficient motive force to cause the desired compounds to flow out of the tank 14. That is not always the case. Therefore, process 100 provides additional motive force for skimming the top of the auxiliary tank 104. Specifically, the auxiliary tank 104 has an inlet 108 that is also near the top of the auxiliary tank 104. That inlet 108 is connected to the outlet 110 of the brew tank 102 and to a gas source 112. The connections to both elements 110, 112 are controlled by valves 114, 116.

With this configuration, when it comes time to skim compounds from the top of the auxiliary tank 104, the inlet 108 can be opened to allow coffee to flow from the brew tank 102 into the auxiliary tank 104. The positioning of the main drain 106 in the auxiliary tank 104 helps to ensure that the entering coffee will skim the top of the auxiliary tank 104.

If gravity does not provide sufficient motive force to move coffee from the brew tank 102 into the auxiliary tank 104 to skim it, motive force can be added. Specifically, in the illustrated embodiment, a gas source 112 is positioned to provide a pressurized gas to move the coffee. The gas in question is preferably a gas that will not react with the coffee itself, such as elemental nitrogen gas. Alternatively, a pump or pumps may be interposed in the lines depicted in FIG. 2 to pump coffee from one tank 102 to the other 104.

With this arrangement, in some cases, the entire volume of the brew tank 102 may be flowed through the auxiliary tank 108 and on to the rest of process 100. If desired, however, a bypass may be installed that allows some of the volume of brewed coffee in the brew tank 102 to flow through the auxiliary tank 108, while another portion of the brewed coffee flows directly into the rest of process 100. As before, the auxiliary tank 108 has a secondary drain 118 in its bottom to drain its entire volume when needed. The primary drain 106 is connected to the other elements of process 100 by a valve 120. From the auxiliary tank 104, the skimmed coffee liquids mixed with coffee are sent to a filter/separator 122 and then to a flash chiller 124, before being placed in an acidified holding tank 126 to await a final drying process, such as lyophilization.

In this embodiment, any gas supplied by the gas source 112 may be allowed to escape to atmosphere in the filter/separator 122, or it may be allowed to escape to atmosphere in the holding tank 126 or at some other point in process 100. As those of skill in the art will understand, a motive gas or pressure built up in the line may assist with the filtration/separation process by which grounds are separated from the coffee.

As was described briefly above, the auxiliary tank 104 need not be “in line” with the rest of the apparatus and process 100, i.e., connected to it. Coffee from the brew tank 102 may be washed into the auxiliary tank 104 to skim it and the resultant fortified mix of coffee may be transported to other equipment and steps in process 100 by other means. As with process 10 described above, in some embodiments, coffee could be brewed in a single tank in batch fashion, such that the tasks described here are performed in different orders.

As used in this description and in the claims below, the term “coffee liquids” refers to the compounds that are skimmed from the top of the auxiliary tank 14, 104. These compounds are presumably dissolved in, suspended in, or otherwise carried by coffee, a liquid, and need not be liquids themselves. Moreover, while this description may focus on a gross physical separation of coffee liquids by skimming them from the top of an auxiliary tank 14, 104, nothing prevents other, additional or alternative separation steps from being inserted into the process. Any additional separation steps may focus, for example, on isolating and fortifying specific compounds.

### Example

200 g of coffee were ground at a setting of 7 on a zero-calibrated MAHLKONIG® EK43 grinder. The grinds were placed into two stacked paper drip filters and brewed on a FETCO 2131XTS drip brewer with a brew water volume of 1 liter, set to 30 water pulses, a 4:30 brew time, and a 205° F. brew temperature. The resulting brewed coffee was flash-chilled in a container that had been sprayed with an acidifier (8 g lemon juice). In a separate container, 12 g ground coffee, prepared as above, were combined with 200 g water for four minutes. After four minutes, the coffee grounds were skimmed from the top of the coffee. Following that, 20 g of liquid coffee from this preparation were siphoned from the top of the container, added to the main brew, and stirred. The resulting combined, fortified coffee brew was lyophilized. The resulting lyophilizate is reconstituted with water at a ratio of 1:70 for consumption.

In this description, the term “about” is used, particularly in association with the description of certain process parameters and ranges. That term should be construed to mean that the actual value may differ from the stated value or range of values so long as the actual value does not change the desired or described result. If it cannot be determined what values would change the desired or described result, the term “about” should be construed to mean±5%.

While the invention has been described with respect to certain embodiments, the description is intended to be exemplary, rather than limiting. Modifications and changes may be made within the scope of the invention, which is defined by the appended claims.

What is claimed is:

1. A method for preparing coffee for drying, comprising:
brewing coffee in a first vessel;
brewing coffee in a second vessel;
separating a volume of coffee liquids from the surface of the coffee in the second vessel;
adding the separated volume of coffee liquids to the coffee brewed in the first vessel to create fortified coffee; and
holding the fortified coffee in a third vessel.

2. The method of claim 1, further comprising, prior to said holding, washing the third vessel with an acidifier.

3. The method of claim 2, wherein the acidifier is lemon juice or fruit-derived citric acid.

4. The method of claim 2, wherein said brewing coffee in the first vessel comprises brewing with a coffee-to-water ratio of 1:5.

5. The method of claim 2, wherein the volume of coffee liquids comprises 20-30 mL per liter of the coffee in the second vessel.

6. The method of claim 2, further comprising, prior to said holding, flash-chilling said fortified coffee.

7. The method of claim 2, further comprising lyophilizing the fortified coffee.

8. The method of claim 2, wherein said separating comprises draining the volume of coffee liquids using a drain placed at a level close to the surface of the coffee in the second vessel.

9. The method of claim 2, further comprising, prior to said holding, separating coffee grounds from the fortified coffee.

10. A method for preparing coffee for drying, comprising:
brewing a first volume of coffee;
brewing a second volume of coffee;
separating a volume of coffee liquids from the surface of the second volume of coffee; and
adding the separated volume of coffee liquids to the first volume of coffee to create fortified coffee.

11. The method of claim 10, further comprising lyophilizing the fortified coffee.

12. The method of claim 10, wherein the first volume of coffee is brewed in a first vessel and the second volume of coffee is brewed in a second vessel.

13. The method of claim 12, wherein said separating comprises flowing the coffee from the first vessel over the surface of the coffee in the second vessel to skim the coffee liquids from the surface.

14. The method of claim 13, further comprising pressurizing the coffee from the first vessel.

15. The method of claim 14, wherein said pressurizing comprises providing a pressurized gas source.

16. The method of claim 10, further comprising holding the fortified coffee in an acidified vessel.

17. A dried coffee produced according to the method of claim 10.

18. The dried coffee of claim 17, wherein the dried coffee is lyophilized coffee.
